(19) United States
(12) Patent Application Publication
(10) Pub. No.: US 2010/0195253 A1
(43) Pub. Date: Aug. 5, 2010

(54) MAGNETORESISTIVE (MR) ELEMENTS HAVING IMPROVED HARD BIAS SEED LAYERS

(76) Inventors: James M. Freitag, Sunnyvale, CA (US); Mustafa M. Pinarbasi, Morgan Hill, CA (US)

Correspondence Address: DUFT BORNSEN & FISHMAN, LLP, 1526 SPRUCE STREET, SUITE 302, BOULDER, CO, 80302, US

(21) Appl. No.: 12/756,264

(22) Filed: Apr. 8, 2010

Related U.S. Application Data
(62) Division of application No. 12/346,324, filed on Dec. 30, 2008.
Application No. 12/346,324 is a continuation-in-part of application No. 11/256,437, filed on Oct. 21, 2005, now abandoned.

(51) Int. Cl. G11B 5/127

(52) U.S. Cl. 360/324.12; G9B/5.04

(57) ABSTRACT

MR devices and associated methods of fabrication are disclosed. An MR device includes an MR element and a bias structure on either side of the MR element for biasing a free layer of the MR element. The bias structure includes an amorphous buffer layer, a first seed layer formed from Cr, a second seed layer formed from a non-magnetic Cr alloy, and a hard bias magnetic layer. The second seed layer formed from the non-magnetic Cr alloy is formed between the Cr seed layer and the hard bias magnetic layer. An example of a non-magnetic Cr alloy is Chromium-Molybdenum (CrMo).

### RELATED APPLICATIONS

The patent application is a divisional of a co-pending U.S. patent application having the Ser. No. 12/346,324 and filed on Dec. 30, 2008, which is a continuation-in-part of a U.S. patent application having the Ser. No. 11/256,437 and filed on Oct. 21, 2005 (abandoned), both of which are incorporated by reference as if fully included herein.

### BACKGROUND OF THE INVENTION

1. Field of the Invention

The invention is related to the field of magnetoresistive (MR) devices and, in particular, to MR devices having improved hard bias seed layers.

2. Statement of the Problem

Many computer systems use magnetic disk drives for mass storage of information. Magnetic disk drives typically include one or more recording heads (sometimes referred to as sliders) that include read elements and write elements. A suspension arm holds the recording head above a magnetic disk. When the magnetic disk rotates, an air flow generated by the rotation of the magnetic disk causes an air bearing surface (ABS) side of the recording head to ride a particular height above the magnetic disk. The height depends on the shape of the ABS. As the recording head rides on the air bearing, an actuator moves an actuator arm that is connected to the suspension arm to position the read element and the write element over selected tracks of the magnetic disk.

To read data from the magnetic disk, transitions on a track of the magnetic disk create magnetic fields. As the read element passes over the transitions, the magnetic fields of the transitions modulate the resistance of the read element. The change in resistance of the read element is detected by passing a sense current through the read element and then measuring the change in voltage across the read element. The resulting signal is used to recover the data encoded on the track of the magnetic disk.

The most common type of read elements are magnetoresistive (MR) read elements. One type of MR read element is a Giant MR (GMR) read element. GMR read elements using only two layers of ferromagnetic material (e.g., NiFe) separated by a layer of nonmagnetic material (e.g., Cu) are generally referred to as spin valve (SV) elements. A simple-pinned SV read element generally includes an antiferromagnetic (AFM) layer, a first ferromagnetic layer, a spacer layer, and a second ferromagnetic layer. The first ferromagnetic layer (referred to as the pinned layer) has its magnetization typically fixed (pinned) by exchange coupling with the AFM layer (referred to as the pinning layer). The pinning layer generally fixes the magnetic moment of the pinned layer perpendicular to the ABS of the recording head. The magnetization of the second ferromagnetic layer, referred to as a free layer, is not fixed and is free to rotate in response to the magnetic field from the magnetic disk. The magnetic moment of the free layer is free to rotate upwardly and downwardly with respect to the ABS in response to positive and negative magnetic fields from the rotating magnetic disk. The free layer is separated from the pinned layer by the nonmagnetic spacer layer.

Another type of SV read element is an antiparallel pinned (AP) SV read element. The AP-pinned spin valve read element differs from the simple pinned SV read element in that an AP-pinned structure has multiple thin film layers forming the pinned layer instead of a single pinned layer. The AP-pinned structure has an antiparallel coupling (APC) layer between first and second ferromagnetic pinned layers. The first pinned layer has a magnetization oriented in a first direction perpendicular to the ABS by exchange coupling with the AFM pinning layer. The second pinned layer is antiparallel exchange coupled with the first pinned layer because of the selected thickness of the APC layer between the first and second pinned layers. Accordingly, the magnetization of the second pinned layer is oriented in a second direction that is antiparallel to the direction of the magnetization of the first pinned layer.

Another type of MR read element is a Magnetic Tunnel Junction (MTJ) read element. The MTJ read element comprises first and second ferromagnetic layers separated by a thin, electrically insulating, tunnel barrier layer. The tunnel barrier layer is sufficiently thin that quantum-mechanical tunneling of charge carriers occurs between the ferromagnetic layers. The tunneling process is electron spin dependent, which means that the tunneling current across the junction depends on the spin-dependent electronic properties of the ferromagnetic materials and is a function of the relative orientation of the magnetic moments, or magnetization directions, of the two ferromagnetic layers. In the MTJ read element, the first ferromagnetic layer has its magnetic moment pinned (referred to as the pinned layer). The second ferromagnetic layer has its magnetic moment free to rotate in response to an external magnetic field from the magnetic disk (referred to as the free layer). When a sense current is applied, the resistance of the MTJ read element is a function of the tunneling current across the insulating layer between the ferromagnetic layers. The tunneling current flows perpendicularly through the tunnel barrier layer, and depends on the relative magnetization directions of the two ferromagnetic layers. A change of direction of magnetization of the free layer causes a change in resistance of the MTJ read element, which is reflected in voltage across the MTJ read element.

GMR read elements and MTJ read elements may be current in plane (CIP) read elements or current perpendicular to plane (CPP) read elements. Read elements have first and second leads for conducting a sense current through the read element. If the sense current is applied parallel to the major planes of the layers of the read element, then the read element is termed a CIP read element. If the sense current is applied perpendicular to the major planes of the layers of the read element, then the read element is termed a CPP read element.

Designers of read elements use different techniques to stabilize the magnetic moment of the free layer. Although the magnetic moment of the free layer is free to rotate upwardly or downwardly with respect to the ABS in response to positive and negative magnetic fields from the magnetic disk, it is important to longitudinally bias the free layer (biased parallel to the ABS and parallel to the major planes of the layers of the read element) to avoid unwanted movement or jitter of the magnetic moment of the free layer. Unwanted movement of the magnetic moment adds noise and unwanted frequencies to the signals read from the read element.

One method used to stabilize the magnetic moment of the free layer is to bias the free layer using first and second hard bias magnetic layers that are adjacent to first and second sides of the read element. Examples of hard bias magnetic layers are CoPt or CoPtCr. The magnetic moments of the hard bias magnetic layers stabilize the magnetic moment of the free layer.

In some instances, seed layers are formed underneath the hard bias magnetic layers. A typical seed layer comprises a Chromium (Cr) layer formed underneath the hard bias magnetic layer. A Cr seed layer is generally thick enough (e.g., between about 250 Å and 350 Å) to position the hard bias magnetic layer at the same level as the free layer of the MR element to longitudinally bias the free layer. The Cr seed layer also increases the coercive force and squareness of the magnetic moment of the hard bias magnetic layers. However, a Cr seed layer or other current seed layers may not provide the level of coercive force and squareness desired, such as for high-density recording applications. It may be desirable to have a seed layer structure that promotes or provides an increased coercive force and squareness for the magnetic moment of the hard bias magnetic layers.

### SUMMARY

The invention solves the above and other related problems with an MR device having a seed layer structure that includes a first seed layer of Cr and a second seed layer of a non-magnetic Cr alloy, such as Chromium-Molybdenum (CrMo). The Cr alloy seed layer is deposited between the Cr seed layer and the hard bias magnetic layer. The properties of the Cr seed layer and the Cr alloy seed layer advantageously provide increased coercivity and squareness for the magnetic field of the hard bias magnetic layer. The hard bias magnetic layer thus provides improved free layer biasing. Improved free layer biasing may be particularly important in high-density recording applications, such as in perpendicular recording where the magnetic field from the magnetic media can be very large.

In one embodiment of the invention, an MR device includes a CIP MR element (e.g., an MR read element) and a bias structure on the sides of the MR element. The bias structure on either side of the MR element includes an amorphous buffer layer, a first seed layer formed from Cr, a second seed layer formed from a non-magnetic Cr alloy (e.g., CrMo), and a hard bias magnetic layer. The MR element is formed with a partial mill process. Thus, the buffer layer is formed on residual MR material remaining on the sides of the MR element. The first seed layer is formed on the buffer layer. The second seed layer is formed on the first seed layer. The hard bias magnetic layer is formed on the second seed layer.

In another embodiment of the invention, an MR device includes a CPP MR element and a bias structure on the sides of the MR element. The bias structure on either side of the MR element includes an amorphous buffer layer, a first seed layer formed from Cr, a second seed layer formed from a non-magnetic Cr alloy, and a hard bias magnetic layer. The buffer layer is formed on a shield exposed on the sides of the MR element. The first seed layer is formed on the buffer layer. The second seed layer is formed on the first seed layer. The hard bias magnetic layer is formed on the second seed layer.

The invention may include other exemplary embodiments described below.

### DESCRIPTION OF THE DRAWINGS

The same reference number represents the same element or same type of element on all drawings.

FIG. 1 illustrates a magnetic disk drive system in an exemplary embodiment of the invention.

FIG. 2 illustrates a recording head in an exemplary embodiment of the invention.

FIG. 3 illustrates a partial composition of a recording head using a CIP structure in an exemplary embodiment of the invention.

FIG. 4 illustrates another partial composition of a recording head using a CIP structure in an exemplary embodiment of the invention.

FIGS. 5-6 illustrate exemplary measurements showing the effect of a CrMo seed layer on coercivity and squareness.

FIG. 7 is a flow chart illustrating a method of fabricating an MR device having a CIP structure in an exemplary embodiment of the invention.

FIG. 8 illustrates a partial composition of a recording head using a CPP structure in an exemplary embodiment of the invention.

FIG. 9 illustrates a more detailed composition of a recording head using a CPP structure in an exemplary embodiment of the invention.

FIG. 10 is a flow chart illustrating a method of fabricating an MR device having a CPP structure in an exemplary embodiment of the invention.

### DETAILED DESCRIPTION OF THE INVENTION

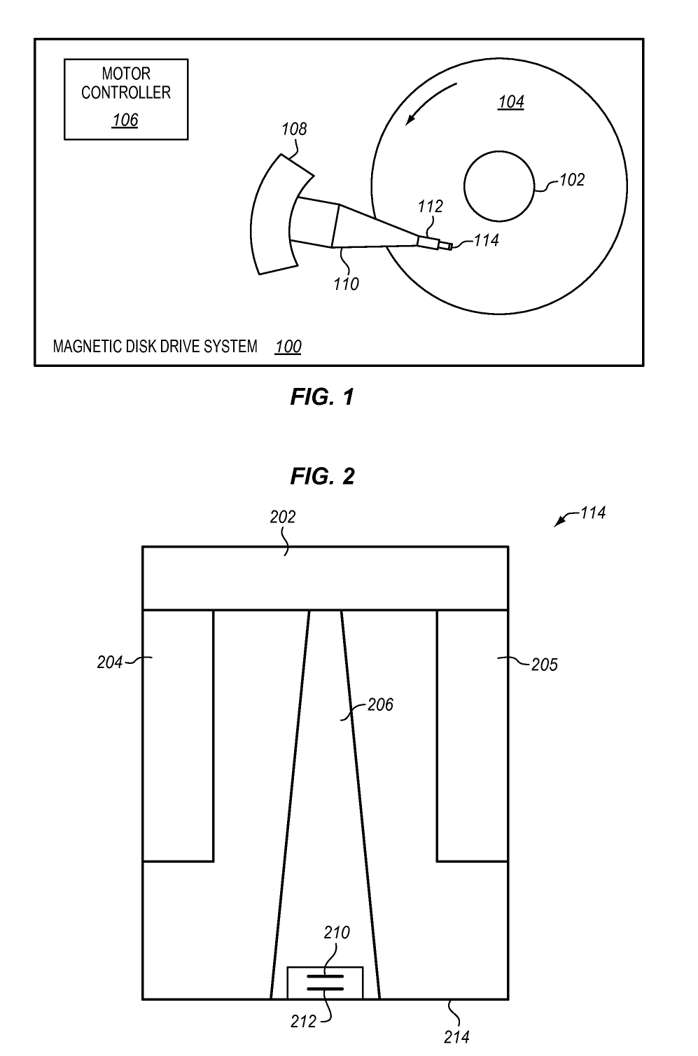

FIGS. 1-10 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a magnetic disk drive system 100 in an exemplary embodiment of the invention. Magnetic disk drive system 100 includes a spindle 102, a magnetic disk 104, a motor controller 106, an actuator 108, an actuator arm 110, a suspension arm 112, and a recording head 114. Spindle 102 supports and rotates a magnetic disk 104 in the direction indicated by the arrow. A spindle motor (not shown) rotates spindle 102 according to control signals from motor controller 106. Recording head 114 is supported by suspension arm 112 and actuator arm 110. Actuator arm 110 is connected to actuator 108 that is configured to rotate in order to position recording head 114 over a desired track of magnetic disk 104. Magnetic disk drive system 100 may include other devices, components, or systems not shown in FIG. 1. For instance, a plurality of magnetic disks, actuators, actuator arms, suspension arms, and recording heads may be used.

When magnetic disk 104 rotates, an air flow generated by the rotation of magnetic disk 104 causes an air bearing surface (ABS) of recording head 114 to ride on a cushion of air a particular height above magnetic disk 104. The height depends on the shape of the ABS. As recording head 114 rides on the cushion of air, actuator 108 moves actuator arm 110 to position a magnetoresistive (MR) read element (not shown) and a write element (not shown) in recording head 114 over selected tracks of magnetic disk 104.

FIG. 2 illustrates recording head 114 in an exemplary embodiment of the invention. The view of recording head 114 is of the ABS side of recording head 114. Recording head 114 has a cross rail 202, two side rails 204-205, and a center rail 206 on the ABS side. The rails on recording head 114 illustrate just one embodiment, and the configuration of the ABS side of recording head 114 may take on any desired form. Recording head 114 also includes a write element 210 and a magnetoresistive (MR) element 212 on a trailing edge 214 of recording head 114.

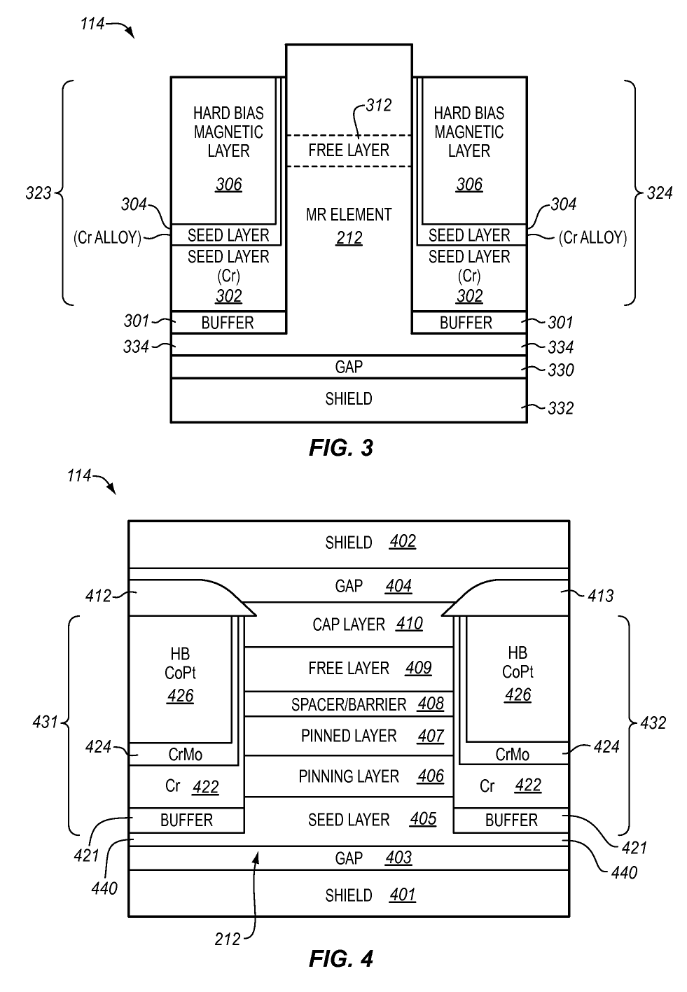

FIG. 3 illustrates a partial composition of recording head 114 using a CIP structure in an exemplary embodiment of the invention. The view of FIG. 3 is from the ABS of recording head 114. Although a recording head 114 of a magnetic disk drive system 100 is referenced in this embodiment, the invention applies equally to any MR device, one example of which is a magnetic recording head 114. An MR device comprises any device used for detecting magnetic fields using MR properties. MR devices may have applications other than magnetic recording, all of which are within the scope of the invention.

MR element 212 is a current in plane (CIP) element in this embodiment. For a CIP design, MR element 212 is formed on a gap layer 330 and a shield 332. To form MR element 212, gap layer 330 is deposited on shield 332, and then layers of MR material are deposited on the gap layer 330. The MR material is then milled or otherwise processed to form MR element 212. After milling, MR element 212 has a first side and a second side, which are its left and right sides looking at FIG. 3. In this embodiment, MR sensor 212 is formed from partial milling, meaning that milling stops before reaching the gap layer 330. Thus, there is excess or residual MR material (indicated by reference number 334) on each side of the MR element 212 on top of the gap layer 330.

A bias structure 323-324 is then formed on each side of MR element 212. Bias structures 323-324 are adapted to longitudinally bias a free layer 312 in MR element 212. Free layer 312 is generally drawn in MR element 212 and is not intended to indicate the actual position of free layer 312. FIG. 3 is also not drawn to scale to indicate the position or thickness of the layers.

Each bias structure 323-324 includes the following layers. Bias structure 323-324 includes a buffer layer 301 formed from an amorphous material, such as Si. Buffer layer 301 is formed on the residual MR material 334 that remains on top of gap layer 330 after the partial mill process. Bias structure 323-324 also includes a first seed layer 302 formed from Chromium (Cr). First seed layer 302 is formed on buffer layer 301. Bias structure 323-324 also includes a second seed layer 304 formed from a non-magnetic Cr alloy. Second seed layer 304 is formed on first seed layer 302. One example of a non-magnetic Cr alloy is Chromium-Molybdenum (CrMo), which may have 20 atomic percent of Mo in one embodiment. Bias structure 323-324 further includes a hard bias magnetic layer 306 formed from a magnetic material. Hard bias magnetic layer 306 is formed on second seed layer 304. Examples of a magnetic material used for hard bias magnetic layer 306 are CoPt and CoPtCr. As indicated in FIG. 3, buffer layer 301 is formed directly on and contacts the residual MR material 334. First seed layer 302 is formed directly on and contacts buffer layer 301. Likewise, second seed layer 304 is formed directly on and contacts first seed layer 302. Hard bias magnetic layer 306 is formed directly on and contacts second seed layer 304.

Buffer layer 301 is formed specifically for bias structures 323-324 so that seed layers 302 and 304, and hard bias magnetic layer 306 are formed on an amorphous layer as opposed to a crystalline layer. For example, in the partial mill structure in FIG. 3, the residual MR material 334 remains on top of gap layer 403 after the milling process. The MR material 334 is crystalline and can affect the growth of seed layers 302 and 304, and hard bias magnetic layer 306. Thus, buffer layer 301 is deposited on the residual MR material 334 to provide an amorphous layer on which to grow seed layers 302 and 304, and hard bias magnetic layer 306. Buffer layer 301 formed beneath seed layers 302 and 304 advantageously retains the high coercivity and squareness of hard bias magnetic layer 306.

Second seed layer 304 added between first seed layer 302 and hard bias magnetic layer 306 provides advantages over prior bias structures. The combination of seed layers 302 and 304 provides substantially increased coercivity and squareness of the magnetic moment of hard bias magnetic layer 306. The interlayer interface between first seed layer 302 and second seed layer 304 also promotes a smaller grain size for hard bias magnetic layer 306.

FIG. 4 illustrates a more detailed composition of recording head 114 using a CIP structure in an exemplary embodiment of the invention. In this embodiment, MR element 212 is sandwiched between a first shield 401 and a second shield 402 and a first gap layer 403 and a second gap layer 404. MR element 212 has a first side and a second side, which are its left and right sides looking at FIG. 4. Leads 412-413 contact MR element 212 on both sides. Recording head 114 also includes bias structures 431-432 on either side of MR element 212, which is described further below.

MR element 212 comprises a seed layer 405, a pinning layer 406, a pinned layer 407, a spacer/barrier layer 408, a free layer 409, and a cap layer 410. MR element 212 may include other layers in other embodiments. Spacer/barrier layer 408 may comprise a spacer layer or a barrier layer depending on the desired configuration of MR element 212. A spacer layer is known to those skilled in the art as a layer of non-magnetic material between a pinned layer and a free layer. The spacer layer contributes to spin-dependent scattering, and may be formed from Cu, Au, or Ag. A barrier layer is known to those skilled in the art as a thin layer of insulating material, such as Al₂O₃ or MgO that allows for quantum-mechanical tunneling of charge carriers. As an example configuration, if MR element 212 comprises a giant magnetoresistive (GMR) read element, then spacer/barrier layer 408 comprises a spacer layer. If MR element 212 comprises a magnetic tunnel junction (MTJ) read element, then spacer/barrier layer 408 comprises a barrier layer.

Bias structures 431-432 are adapted to longitudinally bias a free layer 409 in MR element 212. Each bias structure 431-432 includes the following layers. Bias structure 431-432 includes a buffer layer 421, a Cr seed layer 422, a CrMo seed layer 424, and a hard bias magnetic layer 426. Buffer layer 421 is formed directly on residual MR material 440 to act as a buffer between the crystalline structure of the residual MR material 440 and the Cr seed layer 422. The Cr seed layer 422 is formed entirely from Cr, meaning that it is not an alloy, and is formed directly on buffer layer 421. The CrMo seed layer 424 is formed directly on the Cr seed layer 422. Hard bias magnetic layer 426 is formed from a magnetic material, such as CoPt or CoPtCr. Hard bias magnetic layer 426 is formed directly on the CrMo seed layer 424.

The recording head 114 in FIG. 4 illustrates an ultra contiguous junction (UCJ) configuration. In a UCJ sensor, hard bias magnetic layer 426 is positioned so that its geometrical center is collinear with free layer 409. The combined thickness of the Cr seed layer 422 and the CrMo seed layer 424 is sufficient to position hard bias magnetic layer 426 proximate to free layer 409 in order to bias the magnetic moment of free layer 409 (FIG. 4 is not drawn to scale). As an example, the combination of the Cr seed layer 422 and the CrMo seed layer 424 may be about 300 Å thick to position hard bias magnetic layer 426 at a desired height. The thickness t of the CrMo seed layer 424 may vary depending on desired implementations, such as between about 10 Å and 70 Å. The thickness of the Cr seed layer 422 would then be 300 Å−t.

The combination of the CrMo seed layer 424 and the Cr seed layer 422 provides substantially increased coercivity and squareness of the magnetic moment of hard bias magnetic layer 426. The interlayer interface between the CrMo seed layer 424 and the Cr seed layer 422 also promotes a smaller grain size for hard bias magnetic layer 426.

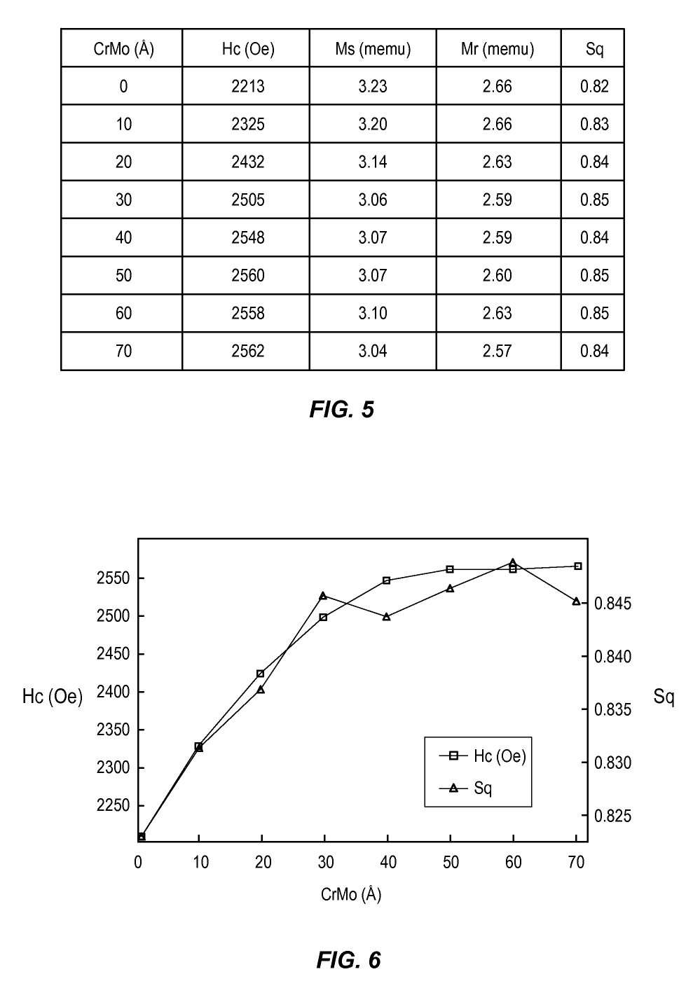

FIGS. 5-6 illustrate exemplary measurements showing the effect of the CrMo seed layer 424 on coercivity and squareness. Referring to both FIGS. 5 and 6, when there is no CrMo seed layer, the coercivity measurement for hard bias magnetic layer 426 is 2213 Oe and the squareness measurement is 0.82. When the CrMo seed layer 424 has a thickness of about 30 Å, the coercivity measurement for hard bias magnetic layer 426 is 2505 Oe and the squareness measurement is 0.85. When the CrMo seed layer 424 has a thickness of about 60 Å, the coercivity measurement for hard bias magnetic layer is 2558 Oe and the squareness measurement is 0.85. Those skilled the art understand that the increase in coercivity and squareness is significant due to the addition of the CrMo seed layer 424 between the Cr seed layer 422 and hard bias magnetic layer 426.

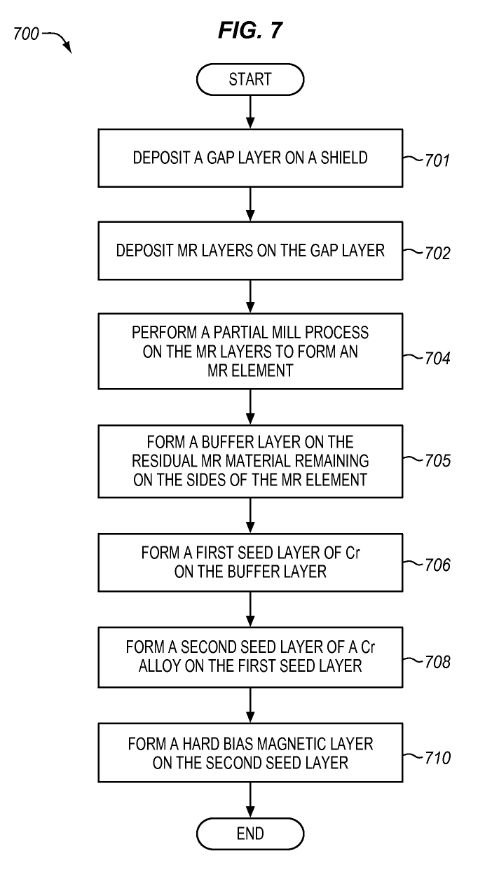

FIG. 7 is a flow chart illustrating a method 700 of fabricating an MR device having a CIP structure in an exemplary embodiment of the invention. The MR device in this embodiment may comprise a magnetic recording head, such as the recording head 114 shown in FIG. 3. Method 700 may include other steps not shown in FIG. 7.

In step 701, a gap layer is deposited on a shield. In step 702, MR layers are deposited on the gap layer. The MR layers that are deposited on the gap layer may include a pinning layer, a pinned layer, a spacer/barrier layer, and a free layer. One or more of the MR layers are also referred to herein generally as MR material.

In step 704, a partial mill process is performed on the MR layers to form an MR element of a desired shape. The partial milling process removes MR material on each side of the MR element, but milling stops before reaching the gap layer. Thus, residual MR material will remain on the sides of the MR element on top of the gap layer. Although the term “milling process” is used, those skilled in the art understand that other types of material-removing processes may be used to selectively remove the MR layers to form the MR element.

In step 705, an amorphous buffer layer is formed directly on the residual MR material remaining on the sides of the MR element. The buffer layer may be formed from Si or another amorphous material. In step 706, a first seed layer of Cr is formed directly on the buffer layer. In step 708, a second seed layer of a non-magnetic Cr alloy is formed directly on the first seed layer. In step 710, a hard bias magnetic layer is formed directly on the second seed layer. Due to the thickness of the first seed layer and the second seed layer, the hard bias magnetic layer is positioned proximate to the free layer of the MR element to bias the magnetic moment of the free layer. The advantages of forming the non-magnetic Cr alloy between the Cr seed layer and the hard bias magnetic layer were expressed above.

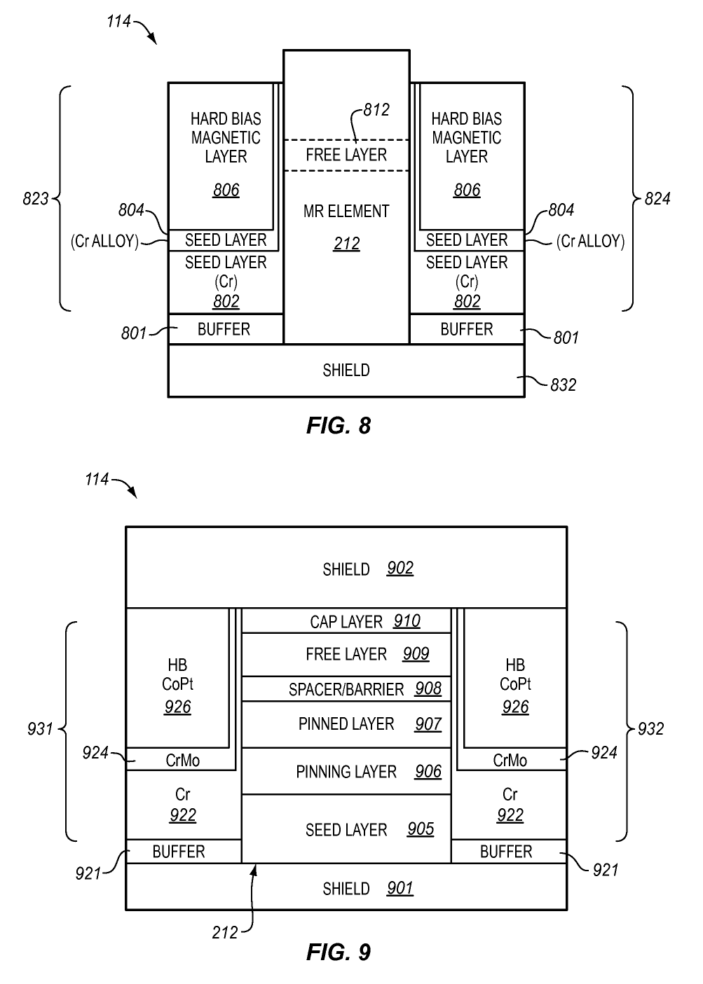

FIG. 8 illustrates a partial composition of recording head 114 using a CPP structure in an exemplary embodiment of the invention. The view of FIG. 8 is from the ABS of recording head 114. MR element 212 is a current perpendicular to plane (CPP) element in this embodiment. For a CPP design, MR element 212 is formed on a shield 832. To form MR element 212, MR material is deposited on shield 832. The MR material is then milled or otherwise processed down to shield 832 to form MR element 212. After milling, MR element 212 has a first side and a second side, which are its left and right sides looking at FIG. 8.

A bias structure 823-824 is then formed on each side of MR element 212. Bias structures 823-824 are adapted to longitudinally bias a free layer 812 in MR element 212. Free layer 812 is generally drawn in MR element 212 and is not intended to indicate the actual position of free layer 812. FIG. 8 is also not drawn to scale to indicate the position or thickness of the layers.

Each bias structure 823-824 includes the following layers. Bias structure 823-824 includes a buffer layer 801 formed from an amorphous material, such as Si. Buffer layer 801 is formed on shield 832. Bias structure 823-824 also includes a first seed layer 802 formed from Chromium (Cr). First seed layer 802 is formed on buffer layer 801. Bias structure 823-824 also includes a second seed layer 804 formed from a non-magnetic Cr alloy. Second seed layer 804 is formed on first seed layer 802. One example of a non-magnetic Cr alloy is CrMo. Bias structure 823-824 further includes a hard bias magnetic layer 806 formed from a magnetic material. Hard bias magnetic layer 806 is formed on second seed layer 804. Examples of a magnetic material used for hard bias magnetic layer 806 are CoPt and CoPtCr. As indicated in FIG. 8, buffer layer 801 is formed directly on and contacts shield 332. First seed layer 802 is formed directly on and contacts buffer layer 801. Likewise, second seed layer 804 is formed directly on and contacts first seed layer 802. Hard bias magnetic layer 806 is formed directly on and contacts second seed layer 804.

Buffer layer 801 is formed specifically for bias structures 823-824 so that seed layers 802 and 804, and hard bias magnetic layer 806 are formed on an amorphous layer as opposed to a crystalline layer. For example, MR material for MR element 212 is formed directly on shield 832 for a CPP structure. The MR material is then milled to form MR element 212. If the MR element 212 is milled down to shield 832, then buffer layer 801 is also deposited on shield 832 on the sides of MR element 212 to provide an amorphous layer on which to grow seed layers 802 and 804, and hard bias magnetic layer 806. Buffer layer 801 formed beneath seed layers 802 and 804 advantageously retains the high coercivity and squareness of hard bias magnetic layer 806.

Second seed layer 804 added between first seed layer 802 and hard bias magnetic layer 806 provides advantages over prior bias structures. The combination of seed layers 802 and 804 provides substantially increased coercivity and squareness of the magnetic moment of hard bias magnetic layer 806. The interlayer interface between first seed layer 802 and second seed layer 804 also promotes a smaller grain size for hard bias magnetic layer 806.

FIG. 9 illustrates a more detailed composition of recording head 114 using a CPP structure in an exemplary embodiment of the invention. In this embodiment, MR element 212 is sandwiched between a first shield 901 and a second shield 902. MR element 212 has a first side and a second side, which are its left and right sides looking at FIG. 9. Recording head 114 also includes bias structures 931-932 on either side of MR element 212, which is described further below.

MR element 212 comprises a seed layer 905, a pinning layer 906, a pinned layer 907, a spacer/barrier layer 908, a free layer 909, and a cap layer 910. MR element 212 may include other layers in other embodiments. Spacer/barrier layer 908 may comprise a spacer layer or a barrier layer depending on the desired configuration of MR element 212.

Bias structures 931-932 are adapted to longitudinally bias a free layer 909 in MR element 212. Each bias structure 931-932 includes the following layers. Bias structure 931-932 includes a buffer layer 921, a Cr seed layer 922, a CrMo seed layer 924, and a hard bias magnetic layer 926. Buffer layer 921 is formed directly on shield 901 to act as a buffer between the crystalline structure of shield 901 and the Cr seed layer 922. The Cr seed layer 922 is formed entirely from Cr, meaning that it is not an alloy, and is formed directly on buffer layer 921. The CrMo seed layer 924 is formed directly on the Cr seed layer 922. Hard bias magnetic layer 926 is formed from a magnetic material, such as CoPt or CoPtCr. Hard bias magnetic layer 926 is formed directly on the CrMo seed layer 924.

The recording head 114 in FIG. 9 also illustrates a UCJ configuration. The combined thickness of the Cr seed layer 922 and the CrMo seed layer 924 is sufficient to position hard bias magnetic layer 926 proximate to free layer 909 in order to bias the magnetic moment of free layer 909 (FIG. 9 is not drawn to scale). As an example, the combination of the Cr seed layer 922 and the CrMo seed layer 924 may be about 300 Å thick to position hard bias magnetic layer 926 at a desired height. The thickness t of the CrMo seed layer 924 may vary depending on desired implementations, such as between about 10 Å and 70 Å. The thickness of the Cr seed layer 922 would then be about 300 Å−t.

The combination of the CrMo seed layer 924 and the Cr seed layer 922 provides substantially increased coercivity and squareness of the magnetic moment of hard bias magnetic layer 926. The interlayer interface between the CrMo seed layer 924 and the Cr seed layer 922 also promotes a smaller grain size for hard bias magnetic layer 926. Because the Cr seed layer 922 is deposited on buffer layer 921 in this embodiment, the effect of the Cr seed layer 922 and the CrMo seed layer 924 on hard bias magnetic layer 926 is enhanced.

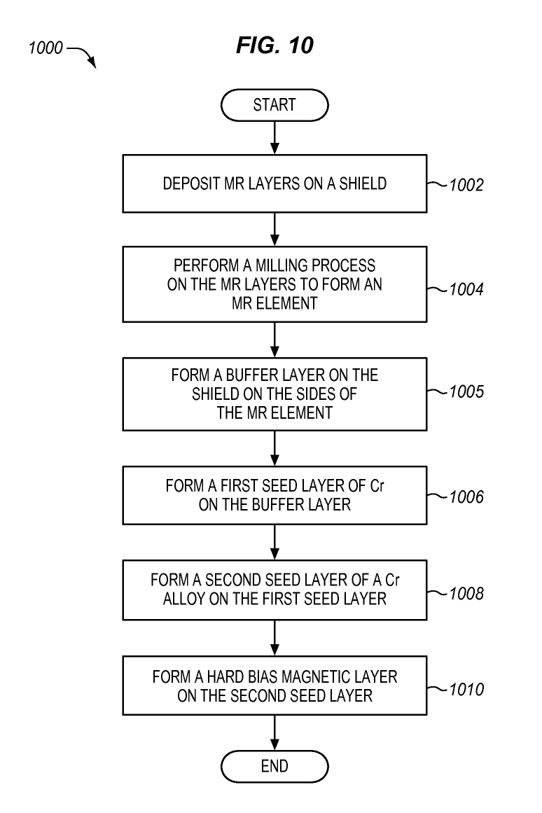

FIG. 10 is a flow chart illustrating a method 1000 of fabricating an MR device having a CPP structure in an exemplary embodiment of the invention. The MR device in this embodiment may comprise a magnetic recording head, such as the recording head 114 shown in FIG. 8. Method 1000 may include other steps not shown in FIG. 10.

In step 1002, MR layers are deposited on a shield. The MR layers that are deposited on the shield may include a pinning layer, a pinned layer, a spacer/barrier layer, and a free layer. One or more of the MR layers are also referred to herein generally as MR material.

In step 1004, a milling process is performed on the MR layers to form an MR element of a desired shape. The milling process removes MR material on each side of the MR element down to the shield. Although the term “milling process” is used, those skilled in the art understand that other types of material-removing processes may be used to selectively remove the MR layers to form the MR element.

In step 1005, an amorphous buffer layer is formed directly on the shield that is exposed on the sides of the MR element. The buffer layer may be formed from Si or another amorphous material. In step 1006, a first seed layer of Cr is formed directly on the buffer layer. In step 708, a second seed layer of a non-magnetic Cr alloy is formed directly on the first seed layer. In step 710, a hard bias magnetic layer is formed directly on the second seed layer. Due to the thickness of the first seed layer and the second seed layer, the hard bias magnetic layer is positioned proximate to the free layer of the MR element to bias the magnetic moment of the free layer. The advantages of forming the non-magnetic Cr alloy between the Cr seed layer and the hard bias magnetic layer were expressed above.

Although specific embodiments were described herein, the scope of the invention is not limited to those specific embodiments. The scope of the invention is defined by the following claims and any equivalents thereof.

We claim:

1. A magnetoresistive (MR) device, comprising:
a current perpendicular to plane (CPP) MR element formed on a shield; and
a bias structure on either side of the CPP MR element configured to bias a magnetic moment of a free layer in the CPP MR element, the bias structure comprising:
an amorphous buffer layer formed directly on the shield;
a first seed layer formed from Cr directly on the amorphous buffer layer;
a second seed layer formed from a non-magnetic Cr alloy directly on the first seed layer; and
a hard bias magnetic layer formed from a magnetic material directly on the second seed layer.

2. The MR device of claim 1 wherein the non-magnetic Cr alloy comprises CrMo.

3. The MR device of claim 1 wherein the hard bias magnetic layer is formed from one of CoPt or CoPtCr.

4. The MR device of claim 1 wherein the amorphous buffer layer comprises Si.

5. A magnetic disk drive system, comprising:
a magnetic disk; and
a recording head operable to read data from the magnetic disk, the recording head comprising:
a first shield and a second shield;
a current perpendicular to plane (CPP) magnetoresistive (MR) element between the first shield and the second shield; and
a bias structure on either side of the CPP MR element configured to bias a magnetic moment of a free layer in the CPP MR element, the bias structure comprising:
an amorphous buffer layer formed directly on the first shield;
a first seed layer formed from Cr directly on the amorphous buffer layer;
a second seed layer formed from a non-magnetic Cr alloy directly on the first seed layer; and
a hard bias magnetic layer formed from a magnetic material directly on the second seed layer.

6. The magnetic disk drive system of claim 5 wherein the non-magnetic Cr alloy comprises CrMo.

7. The magnetic disk drive system of claim 5 wherein the hard bias magnetic layer is formed from one of CoPt or CoPtCr.

8. The magnetic disk drive system of claim 5 wherein the amorphous buffer layer comprises Si.

9. A method of fabricating a magnetoresistive (MR) device, the method comprising:
depositing MR layers on a shield;
performing a milling process on the MR layers to form a current perpendicular to plane (CPP) MR element on the shield;
forming an amorphous buffer layer directly on the shield on the sides of the CPP MR element;
forming a first seed layer of Cr directly on the amorphous buffer layer;
forming a second seed layer of a non-magnetic Cr alloy directly on the first seed layer; and
forming a hard bias magnetic layer directly on the second seed layer.

10. The method of claim 9 wherein the non-magnetic Cr alloy comprises CrMo.

11. The method of claim 9 wherein the hard bias magnetic layer is formed from one of CoPt or CoPtCr.

12. The method of claim 9 wherein the amorphous buffer layer comprises Si.

13. A magnetoresistive (MR) device, comprising:
a current in plane (CIP) MR element formed on a gap layer using a partial milling process; and
a bias structure on either side of the CIP MR element configured to bias a magnetic moment of a free layer in the CIP MR element, the bias structure comprising:
an amorphous buffer layer formed directly on residual MR material remaining on the sides of the CIP MR element due to the partial milling process;
a first seed layer formed from Cr directly on the amorphous buffer layer;
a second seed layer formed from a non-magnetic Cr alloy directly on the first seed layer; and
a hard bias magnetic layer formed from a magnetic material directly on the second seed layer.

14. The MR device of claim 13 wherein the non-magnetic Cr alloy comprises CrMo.

15. The MR device of claim 13 wherein the hard bias magnetic layer is formed from one of CoPt or CoPtCr.

16. The MR device of claim 13 wherein the amorphous buffer layer comprises Si.

17. A method of fabricating a magnetoresistive (MR) device, the method comprising:
depositing a gap layer on a shield;
depositing MR layers on the gap layer;
performing a partial milling process on the MR layers to form a current in plane (CIP) MR element on the gap layer;
forming an amorphous buffer layer directly on residual MR material remaining on the sides of the CIP MR element due to the partial milling process;
forming a first seed layer of Cr directly on the amorphous buffer layer;
forming a second seed layer of a non-magnetic Cr alloy directly on the first seed layer; and
forming a hard bias magnetic layer directly on the second seed layer.

18. The method of claim 17 wherein the non-magnetic Cr alloy comprises CrMo.

19. The method of claim 17 wherein the hard bias magnetic layer is formed from one of CoPt or CoPtCr.

20. The method of claim 17 wherein the amorphous buffer layer comprises Si.
